(19) United States
(12) Patent Application Publication
(10) Pub. No.: US 2007/0223183 A1
(43) Pub. Date: Sep. 27, 2007

(54) Accessory device for a personal electronic device

(76) Inventor: Ian Oja, Viimsi vald (EE)

Correspondence Address: c/o Samuel Shiber, 365 Kearney Circle, Manchester, NH, 03104, US

(21) Appl. No.: 11/303,450

(22) Filed: Dec. 16, 2005

(30) Foreign Application Priority Data
Dec. 16, 2004 (EE) U200400077

(51) Int. Cl. G06F 1/16

(52) U.S. Cl. 361/681

(57) ABSTRACT

An accessory to personal electronic device; the shape of the accessory in most part follows the shape of the electronic device and it has a pocket to keep notes or similar objects in, wherein the accessory is equipped with a coupling device which can be attached to the cover of the electronic device and enables to bring the accessory to a closed or open position, wherein the open position makes the pocket accessible. According to one embodiment, the coupling device is attached to the cover of the electronic device parallel to it, and according to second embodiment the coupling device is perpendicular to the electronic device.

### TECHNICAL FIELD

This invention relates to the field of accessories to personal electronic devices, namely devices connected to electronic pocket notebooks, radio equipment or mobile telephones, and it is meant for keeping in bank notes and credit cards or similar objects.

### STATES OF THE ART

Different cases to carry the mobile telephone in to protect it from accidental scratches, shock, or other external effects are known. Known are both cases from where the telephone has to be removed for the time of use, and cases that do not have to be removed for the time of use of the telephone.

Known are also design solutions for telephone cases with pockets to keep several objects in, such as keys, coins, bank notes and credit cards (see, for example, U.S. Pat. No. 6,729,518, inventor Badillo, patent issued on 4.05. 2004, A45C 15/00, “Carrying case with selectively adjustable stand”, and Pat. No. 6,478,205, inventor Fujihashi, patent issued on 12.11.2002, A45C 1/04, “Case for portable telephones”).

Known are also mobile telephone coverings consisting of two sides, which surround the mobile telephone completely and are attached to one another by means of suitable fasteners. The purpose of such coverings is to protect the mobile telephone or change the appearance of the telephone so that it suits better the surrounding environment (see, for example, U.S. Pat. No. 6,201,867, inventor Koike, patent issued on 13.03.2001, H04M 001/00,“Portable telephone having a removable covering”).

European Patent Application No. EP1345186 A1, inventor“Multiple holder for coins and other articles for personal use” describes a holder, which can be used to keep in coins, mobile telephones, or other objects.

### SUBJECT MATTER OF THE INVENTION

The purpose of the invention lies in designing a solution for keeping in bank notes and credit cards, or similar objects, which can be attached to a personal electronic device (mobile telephone, radio transmitter, pocket notebook or handheld computer) or can be integrated with it.

### LIST OF DRAWINGS

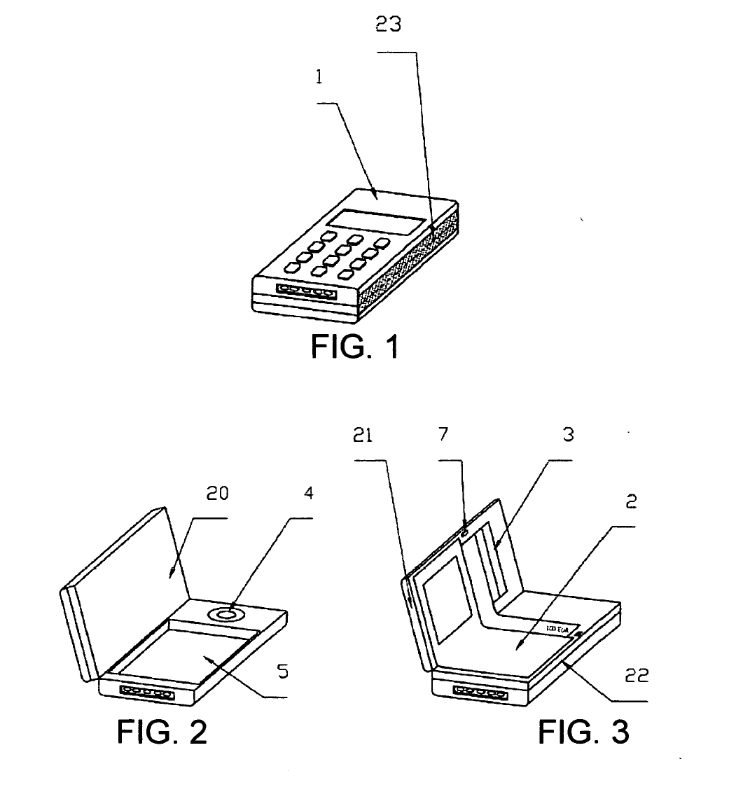

In figure FIG. 1 is depicted an axonometric view of a device in closed position according to one embodiment of the invention;

In figure FIG. 2 is depicted an axonometric view of the embodiment of the invention depicted in FIG. 1 in second position, which enables access to parts of the telephone (to the battery and camera, in the case of the example depicted in the figure);

In figure FIG. 3 is depicted an axonometric view of the embodiment of the invention depicted in FIG. 1 in third position, which enables access to the part of the device designed for keeping credit cards and bank notes in.

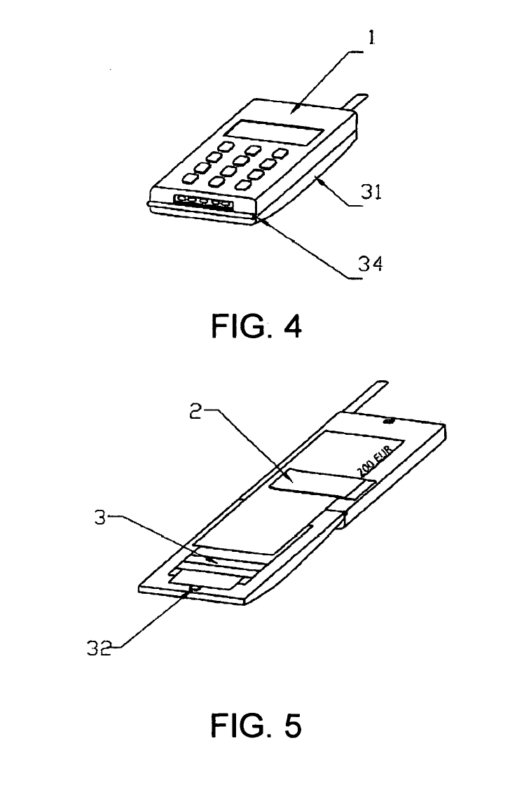

In figure FIG. 4 is depicted an axonometric view of a device in closed position according to second embodiment of the invention;

In figure FIG. 5 is depicted an axonometric view of the embodiment of the invention depicted in FIG. 4 in the second, i.e. open position, which enables access to the part of the device designed for keeping credit cards and bank notes in;

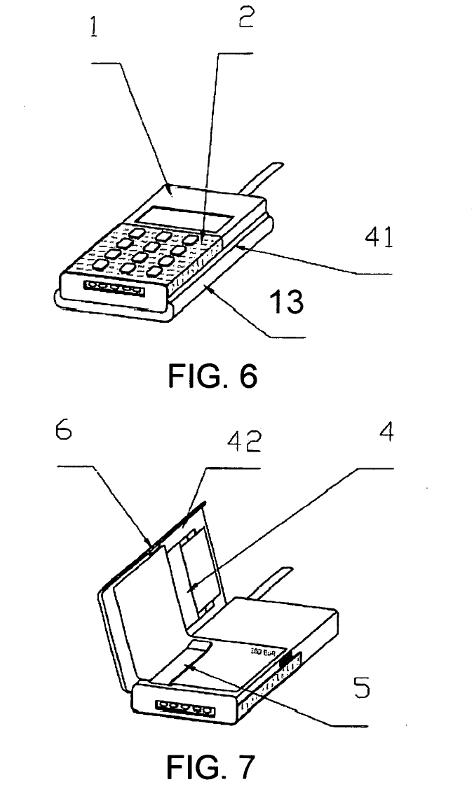

In figure FIG. 6 is depicted an axonometric view of a device in closed position according to third embodiment of the invention; and

In figure FIG. 7 is depicted an axonometric view of the embodiment of the invention depicted in FIG. 6 in the second, i.e. open position, which enables access to the part of the device designed for keeping credit cards and bank notes in;

### EXAMPLES FOR CARRYING OUT THE INVENTION

First example for carrying out the invention is depicted in figures FIG. 1 through FIG. 3. The personal electronic device is a mobile telephone 1, with a camera 4 and battery 5. An accessory 20 according to the invention is attached to the covering of the mobile telephone 1; the accessory consists of two sides, top side 21 and inner side 22. The sides 21 and 22 are attached to the covering of the mobile telephone 1 along the longer edge. Inside the sides 21 and 22, there is a pocket o pockets 2 for keeping bank notes or similar objects in and a pocket or pockets 3 for keeping credit cards or similar objects in. The pocket 2 may extend over both sides (i.e. reach from the inner side of side 20 to the outer side of side 21 as depicted in figure FIG. 3), or the pocket may be attached to one side only. The pocket 3 may be attached to either of the sides or the pocket 3 may be attached to both sides.

Sides 21 and 22 have an open position which enables access to pockets 2 and 3, and a closed position, in which case the sides 21 and 22 are pressed against each other and side 22 is pressed against the covering of the mobile telephone 1. The sides are held in closed position by means of a suitable fastening (similarly with e.g. the fastening 6 depicted in figure FIG.7).

In case of the example depicted in figure FIG. 1, sides 21 and 22 are attached to the covering of the mobile telephone by means of a coupling 23, which is made of a textile strip resistant to recurrent bending or of other suitable material (leather, plastic). The strip 23 is glued to the covering. If the accessory 20 is sold separately from the mobile telephone, the layer of glue on the strip is covered with a cover, which is removed before the installation of the accessory. When the cover has been removed, the adhesive side of the strip is pressed against the covering of the mobile telephone 1 and after that the mobile telephone equipped with the accessory is ready for use.

The strip of coupling 23 may be integrated with one of the sides or both sides 21 and 22, i.e. may be manufactured in a single piece with the sides.

Sides 21 and 22 may be made of the same or different material; suitable materials include, for example, plastic and cardboard, which may be covered with a suitable material, such as leather, imitation leather or textile. Pockets 2 and 3 can be made of the same material as the sides, but other suitable materials, such as transparent plastic film, may be used.

Figures FIG. 4 and 5 depict the second example for carrying out the invention. A cover-shaped element 31, which can be turned between open and closed position, is attached to the covering of the mobile telephone 1 by means of a suitable joint. A fastening 32, which may be made of a Velcro strip, suitable clasp or hook, holds the cover-shaped element in closed position. In open position, pocket(s) 3 for holding credit cards or other objects in are accessible. For money, the accessory is equipped with a spring clip 33. A rod 34, around which the accessory can be turned to open or closed position, serves as a coupling device between the shorter edge of the mobile telephone and the accessory.

Figures FIG. 6 and 7 depict the third example for carrying out the invention. An accessory 13 has been attached to the mobile telephone 1 with a part 2 surrounding the covering of the mobile telephone 1; a coupling device 41 is attached between the part 2 and side 42. There are pockets or a pocket 4 in the side 42 for keeping credit cards or similar objects in. A spring clip 5 holds money in position. A fastening 6 holds the side 42 in closed position.

It is obvious for the person skilled in the art that the scope of protection of the invention described in the claim is not limited to the above specified embodiments, but also extends to solutions which differ from the specifications by features unessential to the nature of the invention. For example, the coupling device may be a rod perpendicular (at right angles to) to the covering of the electronic device and accessory, around which the accessory can be turned into closed or open position. The accessory can be attached to an electronic device by means of parallel rails so that the accessory can be shifted between the open and closed position in the direction of the longitudinal or transversal axis of the device.

1. An accessory to personal electronic device; the shape of the accessory in most part follows the shape of the electronic device and it has a pocket to keep bank notes or similar objects in, wherein the accessory is equipped with a coupling device which can be attached to the cover of the electronic device and enables to bring the accessory to closed or open position, wherein the open position makes the pocket accessible.

2. Device as in claim 1, wherein a personal electronic device has first and second dimension wherein the second dimension is smaller than the first dimension and the coupling device consists of at least one hinge, which is in most part attached to the personal electronic device parallel to the second dimension.

3. Device as in claim 1, wherein a personal electronic device has first and second dimension wherein the second dimension is smaller than the first dimension and the coupling device consists of at least one hinge, which is in most part attached to the personal electronic device parallel to the first dimension.

4. Device as in claim 1, wherein the coupling device is made of an inelastic strip, which is attached to the cover of the electronic device.

5. Device as in claim 2, wherein the coupling device is made of an inelastic strip, which is attached to the cover of the electronic device.

6. Device as in claim 3, wherein the coupling device is made of an inelastic strip, which is attached to the cover of the electronic device.

7. Device as in claim 4, wherein the strip is covered with glue to enable attaching the accessory to the cover of the electronic device.

8. Device as in claim 5, wherein the strip is covered with glue to enable attaching the accessory to the cover of the electronic device.

9. Device as in claim 6, wherein the strip is covered with glue to enable attaching the accessory to the cover of the electronic device.

10. Device as in claim 5, wherein the strip is integrated with the accessory.

11. Device as in claim 7, wherein the strip is integrated with the accessory.

12. Device as in claim 8, wherein the strip is integrated with the accessory.

13. Device as in claim 1, wherein the coupling device consists of a rod perpendicular to the cover of the electronic device and the accessory and the accessory can be turned into open or closed position around the rod.

14. Device as in claim 1, wherein the coupling device consists of parallel rails attached to the cover of the electronic device and the accessory, wherein the accessory can be shifted to open or closed position in the direction of the longitudinal axis of the electronic device.

15. Device as in claim 1, wherein the accessory additionally includes a part surrounding the electronic device and the coupling device is attached to the part surrounding the electronic device.

16. Device as in claim 1, wherein the coupling device is integrated with the cover of the electronic device.
